(19) United States
(12) Patent Application Publication
(10) Pub. No.: US 2011/0268558 A1
(43) Pub. Date: Nov. 3, 2011

(54) NOISE REDUCER FOR ROTOR BLADE IN WIND TURBINE

(75) Inventors: Howard D. Driver, Greer, SC (US); Wendy Wen-Ling Lin, Niskayuna, NY (US)

(73) Assignee: GENERAL ELECTRIC COMPANY, Schenectady, NY (US)

(21) Appl. No.: 12/972,806

(22) Filed: Dec. 20, 2010

(51) Int. Cl. F04D 29/66; B64C 27/46

(52) U.S. Cl. 415/119; 416/228

(57) ABSTRACT

A rotor blade assembly for a wind turbine is disclosed. The rotor blade assembly includes a rotor blade having surfaces defining a pressure side, a suction side, a leading edge, and a trailing edge extending between a tip and a root. The rotor blade assembly further includes a noise reducer mounted to a surface of the rotor blade, the noise reducer comprising a plurality of noise reduction features. The rotor blade assembly further includes a bond layer disposed between the noise reducer and the rotor blade for bonding the noise reducer to the rotor blade, the bond layer having a shear modulus approximately equal to or less than 500 megapascals.

### FIELD OF THE INVENTION

The present disclosure relates in general to wind turbine rotor blades, and more particularly to materials for mounting noise reducers to the rotor blades.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

In many cases, various components are attached to the rotor blades of wind turbines to perform various functions during operation of the wind turbines. These components may frequently be attached adjacent to the trailing edges of the rotor blades. For example, noise reducers may be attached to the trailing edges of the rotor blades to reduce the noise and increase the efficiency associated with the rotor blade.

Typical prior art noise reducers may have a variety of disadvantages. For example, many currently known noise reducers include features that cause increased strains on the noise reducers when mounted to the rotor blades. Additionally, the bonding materials utilized to mount the noise reducers to the rotor blades may further increase these strains. For example, when the rotor blade experiences various strains during operation or otherwise, these strains are translated from the rotor blade to the noise reducers that utilize currently known mounting and bonding features.

Thus, an improved noise reducer for a rotor blade would be desired. For example, a noise reducer with features for reducing the strain associated with mounting the noise reducer to a rotor blade would be desired. In particular, a noise reducer with features for reducing or preventing rotor blade strain from being translated to the noise reducer would be advantageous.

### BRIEF DESCRIPTION OF THE INVENTION

Aspects and advantages of the invention will be set forth in part in the following description, or may be obvious from the description, or may be learned through practice of the invention.

In one embodiment, a rotor blade assembly for a wind turbine is disclosed. The rotor blade assembly includes a rotor blade having surfaces defining a pressure side, a suction side, a leading edge, and a trailing edge extending between a tip and a root. The rotor blade assembly further includes a noise reducer mounted to a surface of the rotor blade, the noise reducer comprising a plurality of noise reduction features. The rotor blade assembly further includes a bond layer disposed between the noise reducer and the rotor blade for bonding the noise reducer to the rotor blade, the bond layer having a shear modulus approximately equal to or less than 500 megapascals.

In another embodiment, a rotor blade assembly for a wind turbine is disclosed. The rotor blade assembly includes a rotor blade having surfaces defining a pressure side, a suction side, a leading edge, and a trailing edge extending between a tip and a root. The rotor blade assembly further includes a noise reducer mounted to a surface of the rotor blade, the noise reducer comprising a plurality of noise reduction features. The rotor blade assembly further includes a bond layer disposed between the noise reducer and the rotor blade for bonding the noise reducer to the rotor blade, the bond layer comprising an inner acrylic foam layer disposed between opposing outer adhesive layers.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of one embodiment of a wind turbine of the present disclosure;

FIG. 2 is a perspective view of one embodiment of a rotor blade assembly of the present disclosure;

FIG. 3 is a cross-sectional view of one embodiment of a rotor blade assembly of the present disclosure; and,

FIG. 4 is a cross-sectional view of one embodiment of a bond layer of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

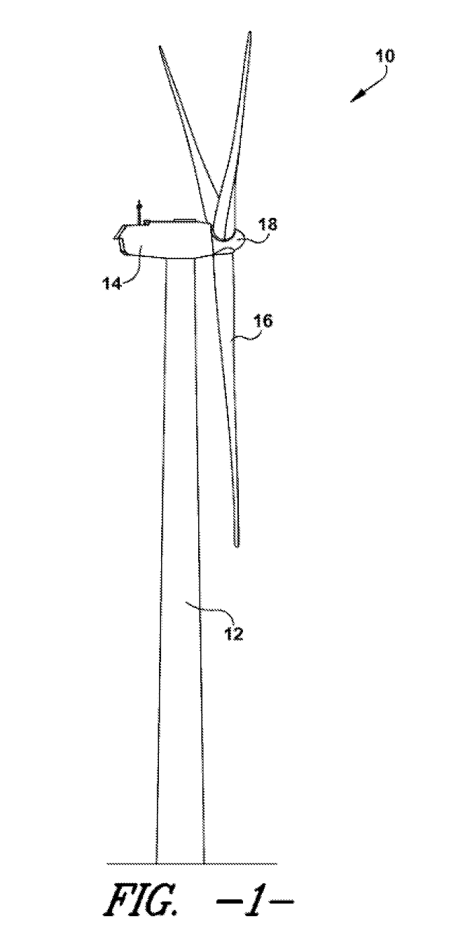

FIG. 1 illustrates a wind turbine 10 of conventional construction. The wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration.

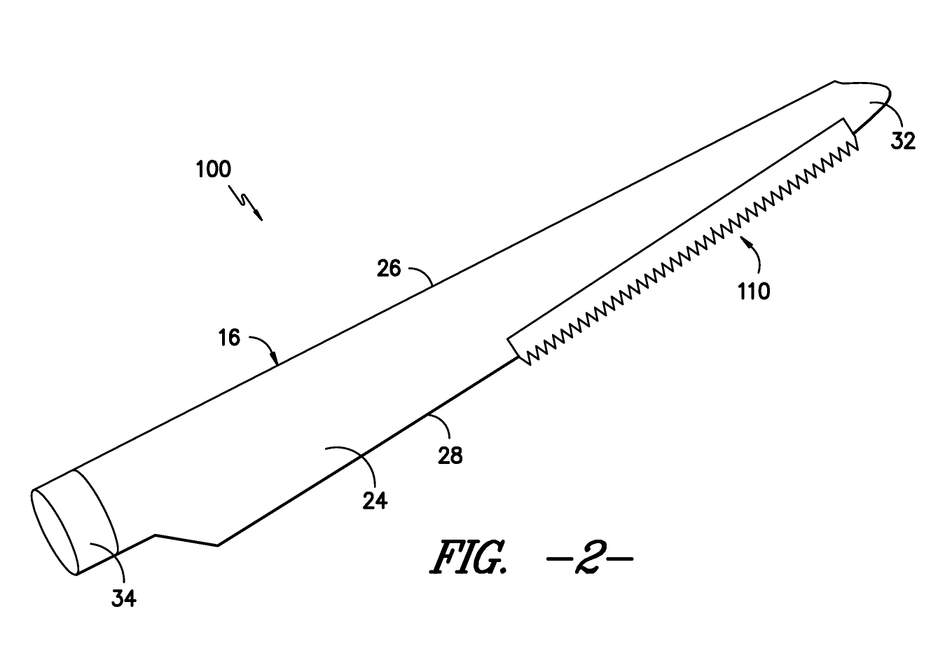

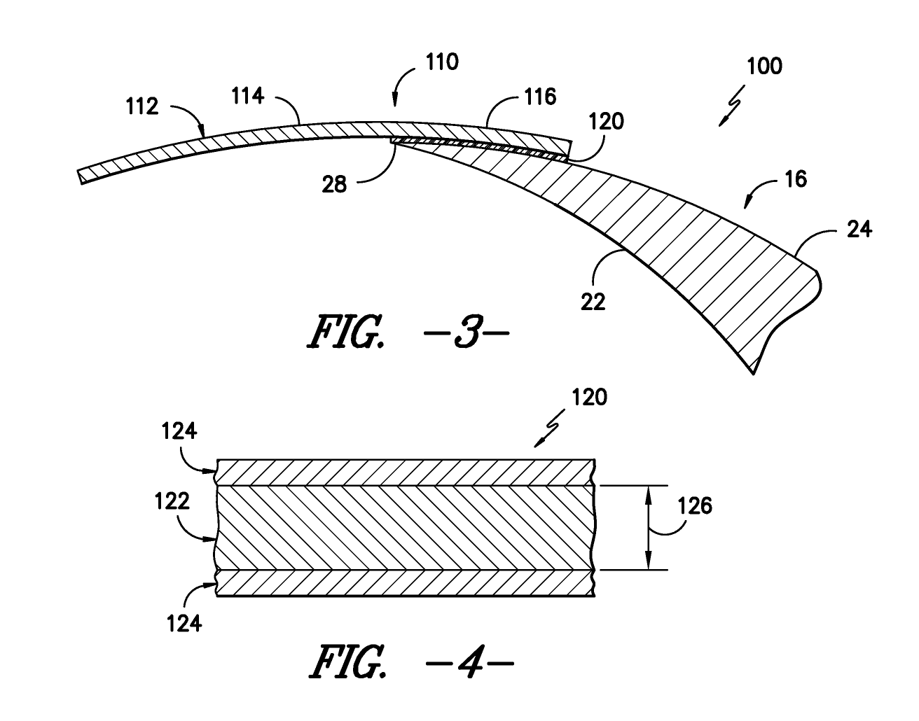

Referring to FIG. 2, a rotor blade 16 according to the present disclosure may include surfaces defining a pressure side 22 (see FIG. 3) and a suction side 24 extending between a leading edge 26 and a trailing edge 28, and may extend from a blade tip 32 to a blade root 34.

In some embodiments, the rotor blade 16 may include a plurality of individual blade segments aligned in an end-to-end order from the blade tip 32 to the blade root 34. Each of the individual blade segments may be uniquely configured so that the plurality of blade segments define a complete rotor blade 16 having a designed aerodynamic profile, length, and other desired characteristics. For example, each of the blade segments may have an aerodynamic profile that corresponds to the aerodynamic profile of adjacent blade segments. Thus, the aerodynamic profiles of the blade segments may form a continuous aerodynamic profile of the rotor blade 16. Alternatively, the rotor blade 16 may be formed as a singular, unitary blade having the designed aerodynamic profile, length, and other desired characteristics.

The rotor blade 16 may, in exemplary embodiments, be curved. Curving of the rotor blade 16 may entail bending the rotor blade 16 in a generally flapwise direction and/or in a generally edgewise direction. The flapwise direction may generally be construed as the direction (or the opposite direction) in which the aerodynamic lift acts on the rotor blade 16. The edgewise direction is generally perpendicular to the flapwise direction. Flapwise curvature of the rotor blade 16 is also known as pre-bend, while edgewise curvature is also known as sweep. Thus, a curved rotor blade 16 may be pre-bent and/or swept. Curving may enable the rotor blade 16 to better withstand flapwise and edgewise loads during operation of the wind turbine 10, and may further provide clearance for the rotor blade 16 from the tower 12 during operation of the wind turbine 10.

As illustrated in FIGS. 2 and 3, the present disclosure may further be directed to a rotor blade assembly 100. The rotor blade assembly 100 may include a noise reducer 110 and a rotor blade 16. In general, the noise reducer 110 may be mounted to a surface of the rotor blade 16, and may reduce the aerodynamic noise being emitted from the rotor blade 16 during operation of the wind turbine 10 and/or may increase the efficiency of the rotor blade 16. In an exemplary embodiment of the present disclosure, the noise reducer 110 may be mounted to the rotor blade 16 on or adjacent to the trailing edge 28 of the rotor blade 16. Alternatively, the noise reducer 110 may be mounted to the rotor blade 16 on or adjacent to the leading edge 26 of the rotor blade 16, or on or adjacent to the tip 32 or the root 34 of the rotor blade 16, or at any other suitable position on any surface of the rotor blade 16. For example, in exemplary embodiments the noise reducer 110 may be mounted on the suction side 24 of the rotor blade 16, such as on the suction side 24 adjacent the trailing edge 28. In alternative embodiments, the noise reducer 110 may be mounted on the pressure side 22, such as on the pressure side 22 adjacent the trailing edge 28.

The noise reducer 110 may further include a plurality of noise reduction features 112. As described herein and illustrated in FIGS. 2 and 3, the noise reduction features 112 in exemplary embodiments are serrations 114. However, it should be understood that the noise reduction features 112 are not limited to serrations 114. For example, in some alternative embodiments the noise reduction features 112 may be bristles. Further, any suitable noise reduction features 112 are within the scope and spirit of the present disclosure.

As shown in FIGS. 2 and 3, the noise reduction features 112, such as the serrations 114, may extend generally from the rotor blade 16. While in exemplary embodiments the serrations 114 are generally V-shaped, in alternative embodiments the serrations 114 may be U-shaped, or may have any other shape or configuration suitable for reducing the noise being emitted from and/or increasing the efficiency of the rotor blade 16 during operation of the wind turbine 10.

It should be understood that the noise reduction features 112 according to the present disclosure may have any suitable characteristics, such as widths, lengths, shapes, or orientations, depending on the desired noise reduction characteristics for the noise reducer 110. Further, individual noise reduction features 112 may have individual characteristics, or various groups of noise reduction features 112 may have similar characteristics, or all noise reduction features 112 may have similar characteristics, depending on the desired noise reduction characteristics for the noise reducer 110.

In some exemplary embodiments, as shown in FIGS. 2 and 3, the noise reducer 112 may include a base plate 116. The base plate 116 in these embodiments may generally be that portion of the noise reducer 110 that is mounted to the rotor blade 16, and the noise reduction features 112 may extend from the base plate 116. Alternatively, the noise reduction features 112 may be mounted directly to the mounting plate 110, and extend directly from the mounting plate 110.

As discussed above, the noise reducer 110 may be mounted to a surface of the rotor blade 16. Thus, the present disclosure is further directed to a bond layer 120 for mounting the noise reducer 110 to a surface of the rotor blade 16. As discussed below, the bond layer 120 may advantageously have various characteristics for reducing the strain associated with mounting the noise reducer 110 to the rotor blade 16. As shown in FIGS. 3 and 4, for example, the bond layer 120 may be disposed between the noise reducer 110 and the rotor blade 16, and may bond the noise reducer 110 to the rotor blade 16. The bond layer 120 may be disposed between the noise reduction features 112 or any portions thereof, and/or between the base plate 116 or any portions thereof, and a surface of the rotor blade 16 or any portions thereof. Further, if an intermediate component, device, or layer is disposed between the rotor blade 16 and noise reducer 110, the bond layer 120 may be utilized to bond the rotor blade 16 and/or the noise reducer 110 to the intermediate component.

As mentioned, the bond layer 120 according to the present disclosure has various characteristics for reducing the strain associated with mounting the noise reducer 110 to the rotor blade 16. The bond layer 120 may thus at least partially absorb strain from the rotor blade 16 and prevent this strain from being transmitted to the noise reducer 110. The bond layer 120 may thus generally be formed from materials that are relatively flexible and relatively tough. In exemplary embodiments, the bond layer 120 may generally isolate the strain associated with the rotor blade 16. By generally isolating the strain, the bond layer 120 may generally prevent a relatively substantial portion of the rotor blade 16 strain from being transmitted through the bond layer 120 to the noise reducer 110.

In exemplary embodiments, for example, the bond layer 120 may be relatively elastic, and may thus have a relatively low shear modulus. The shear modulus may be determined over suitable environmental conditions or ranges of environmental conditions generally expected for a wind turbine 10. For example, in some embodiments, the shear modulus of the bond layer 120 may be approximately equal to or less than 500 megapascals. In other embodiments, the bond layer 120 may have a shear modulus approximately equal to or less than 300 megapascals, approximately equal to or less than 100 megapascals, approximately equal to or less than 20 megapascals, or approximately equal to or less than 10 megapascals. In other exemplary embodiments, the bond layer 120 may have a shear modulus approximately equal to or less than 5 megapascals, or in the range between approximately 5 megapascals and approximately 0.1 megapascals. The relatively low shear modulus of the bond layer 120 may advantageously allow the bond layer 120 to absorb strain from the rotor blade 16 and reduce or prevent the strain being transmitted through the bond layer 120 to the noise reducer 110. In some exemplary embodiments, a bond layer 120 with a shear modulus of, for example, approximately equal to or less than 5 megapascals or in the range between approximately 5 megapascals and approximately 0.1 megapascals, may be considered “generally strain isolating”, such that the bond layer 120 generally isolates a relatively substantial portion of the strain associated with the rotor blade 16, as discussed above.

It should be understood, however, that the present disclosure is not limited to bond layers 120 having a shear modulus as discussed above, but rather that any bond layer 120 with any shear modulus value that is suitable for absorbing strain from the rotor blade 16 and reducing or preventing the strain being transmitted through the bond layer 120 to the noise reducer 110 is within the scope and spirit of the present disclosure.

In some embodiments, the bond layer 120 may comprise an epoxy. The bond layer 120 according to these embodiments may be relatively flexible and tough. For example, the bond layer 120 may include epoxy and have a shear modulus of approximately equal to or less than 300 megapascals. It should be understood, however, that a bond layer 120 including an epoxy may have any suitable shear modulus, such as a shear modules in any suitable range disclosed above. Further, it should be understood that any epoxy, modified epoxy, or substance comprising an epoxy that is suitable for absorbing strain from the rotor blade 16 and reducing or preventing the strain being transmitted through the bond layer 120 to the noise reducer 110 is within the scope and spirit of the present disclosure.

In other embodiments, the bond layer 120 may comprise a polyurethane. The bond layer 120 according to these embodiments may be relatively flexible and tough. For example, the bond layer 120 may include polyurethane and have a shear modulus of approximately equal to or less than 20 megapascals. It should be understood, however, that a bond layer 120 including a polyurethane may have any suitable shear modulus, such as a shear modules in any suitable range disclosed above. Further, it should be understood that any polyurethane, modified polyurethane, or substance comprising a polyurethane that is suitable for absorbing strain from the rotor blade 16 and reducing or preventing the strain being transmitted through the bond layer 120 to the noise reducer 110 is within the scope and spirit of the present disclosure.

In other embodiments, the bond layer 120 may comprise a methacrylate, such as methyl methacrylate. The bond layer 120 according to these embodiments may be relatively flexible and tough. For example, the bond layer 120 may include a methacrylate and have any suitable shear modulus, such as a shear modules in any suitable range disclosed above. It should be understood that any methacrylate, modified methacrylate, or substance comprising a methacrylate that is suitable for absorbing strain from the rotor blade 16 and reducing or preventing the strain being transmitted through the bond layer 120 to the noise reducer 110 is within the scope and spirit of the present disclosure.

In yet other exemplary embodiments, the bond layer 120 may include an acrylic. The acrylic may be an acrylic foam, such as a closed cell acrylic foam, or any acrylic solid or non-foam. The bond layer 120 according to these embodiments may be relatively flexible and tough. For example, the bond layer 120 may include an acrylic and have a shear modulus of approximately equal to or less than 5 megapascals, or in the range between approximately 5 megapascals and approximately 0.1 megapascals. It should be understood, however, that a bond layer 120 including an acrylic may have any suitable shear modulus, such as a shear modulus in any suitable range disclosed above. Further, it should be understood that any acrylic, modified acrylic, or substance comprising an acrylic that is suitable for absorbing strain from the rotor blade 16 and reducing or preventing the strain being transmitted through the bond layer 120 to the noise reducer 110 is within the scope and spirit of the present disclosure.

FIG. 4 illustrates one exemplary embodiment of the bond layer 120 according to the present disclosure. In this embodiment, the bond layer 120 may comprise an inner layer 122 and a plurality of outer layers 124. The inner layer 122 is disposed between the opposing outer layers 124.

The inner layer 122 may comprise, for example, an epoxy, a polyurethane, a methacrylate, or an acrylic. In exemplary embodiments, the inner layer 122 is an acrylic foam. Further, the acrylic foam may be a closed cell acrylic foam. In some exemplary embodiments, the inner acrylic foam layer 122 has a shear modulus of approximately equal to or less than 5 megapascals, or in the range between approximately 5 megapascals and approximately 0.1 megapascals. Thus, in exemplary embodiments, the bond layer 120 including the inner acrylic foam layer 122 may be considered “generally strain isolating”, such that the bond layer 120 generally isolates a relatively substantial portion of the strain associated with the rotor blade 16, as discussed above.

The inner layer 122 may define a thickness 126. In some embodiments, such as when the inner layer 122 is an inner acrylic foam layer 122, the thickness 126 may be in the range between approximately 0.1 millimeters and approximately 10 millimeters. Alternatively, the thickness 126 may be in the range between approximately 0.3 millimeters and approximately 10 millimeters, or in the range between approximately 0.3 millimeters to approximately 3 millimeters, or in the range between approximately 0.5 millimeters and approximately 10 millimeters, or in the range between approximately 0.5 millimeters and approximately 3 millimeters, or in the range between approximately 0.6 millimeters and approximately 3 millimeters, or in the range between approximately 0.6 millimeters and approximately 1 millimeter. It should be understood, however, that the present disclosure is not limited to bond layers 120 with inner layers 122 having certain thicknesses 126, and rather that any thickness of the inner layer and bond layer that is suitable for absorbing strain from the rotor blade 16 and reducing or preventing the strain being transmitted through the bond layer 120 to the noise reducer 110 is within the scope and spirit of the present disclosure.

The outer layers 124 may generally be configured to mount the noise reducer 110 to the rotor blade 16. In exemplary embodiments, the outer layers 124 comprise adhesives and are outer adhesive layers 124. For example, in some exemplary embodiments, the outer layers 124 may comprise acrylic adhesives. However, it should be understood that the outer layers 124 are not limited to acrylic adhesives, and rather that any suitable adhesive is within the scope and spirit of the present disclosure. The adhesives are generally disposed on the outer surfaces of the outer layers 124 to adhere to, for example, the noise reducer 110 and/or rotor blade 16. The inner layer 122 may generally be coated to the inner surfaces of the outer layers 124 to form the bond layer 120.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade assembly for a wind turbine, comprising:
a rotor blade having surfaces defining a pressure side, a suction side, a leading edge, and a trailing edge extending between a tip and a root;
a noise reducer mounted to a surface of the rotor blade, the noise reducer comprising a plurality of noise reduction features; and,
a bond layer disposed between the noise reducer and the rotor blade for bonding the noise reducer to the rotor blade, the bond layer having a shear modulus approximately equal to or less than 500 megapascals.

2. The rotor blade assembly of claim 1, wherein the bond layer has a shear modulus approximately equal to or less than 300 megapascals.

3. The rotor blade assembly of claim 1, wherein the bond layer has a shear modulus approximately equal to or less than 20 megapascals.

4. The rotor blade assembly of claim 1, wherein the bond layer has a shear modulus approximately equal to or less than 5 megapascal.

5. The rotor blade assembly of claim 1, wherein the bond layer is configured to generally isolate the strain associated with the rotor blade.

6. The rotor blade assembly of claim 1, wherein the bond layer comprises at least one of an epoxy, a polyurethane, a methacrylate, and an acrylic.

7. The rotor blade assembly of claim 1, wherein the bond layer comprises an inner acrylic foam layer disposed between opposing outer adhesive layers, and wherein the inner acrylic foam layer has a shear modulus approximately equal to or less than 5 megapascals.

8. The rotor blade assembly of claim 7, wherein the inner acrylic foam layer comprises a closed cell acrylic foam.

9. The rotor blade assembly of claim 7, wherein the inner acrylic foam layer has a thickness in the range between approximately 0.1 millimeters and approximately 10 millimeters.

10. The rotor blade assembly of claim 7, wherein the inner acrylic foam layer has a thickness in the range between approximately 0.3 millimeters and approximately 3 millimeters.

11. The rotor blade assembly of claim 7, wherein the inner acrylic foam layer has a shear modulus in the range between approximately 5 megapascals and approximately 0.1 megapascals.

12. A rotor blade assembly for a wind turbine, comprising:
a rotor blade having surfaces defining a pressure side, a suction side, a leading edge, and a trailing edge extending between a tip and a root;
a noise reducer mounted to a surface of the rotor blade, the noise reducer comprising a plurality of noise reduction features; and,
a bond layer disposed between the noise reducer and the rotor blade for bonding the noise reducer to the rotor blade, the bond layer comprising an inner acrylic foam layer disposed between opposing outer adhesive layers.

13. The rotor blade assembly of claim 12, wherein the bond layer is configured to generally isolate the strain associated with the rotor blade.

14. The rotor blade assembly of claim 12, wherein the inner acrylic foam layer comprises a closed cell acrylic foam.

15. The rotor blade assembly of claim 12, wherein the inner acrylic foam layer has a thickness in the range between approximately 0.1 millimeters and approximately 10 millimeters.

16. The rotor blade assembly of claim 12, wherein the inner acrylic foam layer has a thickness in the range between approximately 0.3 millimeters and approximately 3 millimeters.

17. The rotor blade assembly of claim 12, wherein the inner acrylic foam layer has a shear modulus approximately equal to or less than 5 megapascals.

18. The rotor blade assembly of claim 12, wherein the inner acrylic foam layer has a shear modulus in the range between approximately 5 megapascals and approximately 0.1 megapascals.

19. A wind turbine, comprising:
a plurality of rotor blades, each of the plurality of rotor blades having surfaces defining a pressure side, a suction side, a leading edge, and a trailing edge extending between a tip and a root;
a noise reducer mounted to a surface of at least one of the plurality of rotor blades, the noise reducer comprising a plurality of noise reduction features; and,
a bond layer disposed between the noise reducer and the rotor blade for bonding the noise reducer to the rotor blade, the bond layer having a shear modulus approximately equal to or less than 500 megapascals.

20. The wind turbine of claim 19, wherein the bond layer comprises at least one of an epoxy, a polyurethane, a methacrylate, and an acrylic.
